(19) United States
(12) Patent Application Publication
(10) Pub. No.: US 2015/0085146 A1
(43) Pub. Date: Mar. 26, 2015

(54) METHOD AND SYSTEM FOR STORING CONTACT INFORMATION IN AN IMAGE USING A MOBILE DEVICE

(71) Applicant: Nvidia Corporation, Santa Clara, CA (US)

(72) Inventor: Jaiprakash Khemkar, Pune (IN)

(73) Assignee: Nvidia Corporation, Santa Clara, CA (US)

(21) Appl. No.: 14/033,876

(22) Filed: Sep. 23, 2013

(51) Int. Cl. H04N 5/77; G06K 9/78; H04N 5/232; G06K 9/00; H04N 1/00; H04N 5/225

(52) U.S. Cl. CPC H04N 5/772; H04N 1/00233; H04N 5/2257; H04N 5/23293; G06K 9/00221; G06K 9/78; H04N 2201/0084; G06K 2209/27
USPC 348/207.1; 348/231.3

(57) ABSTRACT

Using face detection procedures, embodiments of the present invention can detect the presence of multiple of contacts within an image. Embodiments of the present invention can also associate the faces detected within the image with contacts belonging to a list of contacts stored on a mobile device. Additionally, embodiments of the present invention are operable to store contact information associated with recognizable contacts found into the image. In this fashion, upon rendering an image, the user can automatically call a contact in the image by clicking on the contact's image or can automatically create a conference call by clicking on more than one contact present in the image. Furthermore, embodiments of the present invention allow users to provide contact information manually during storage procedures for any unrecognized subjects found in the image. Furthermore, embodiments of the present invention can encrypt contact information stored within the image.

### FIELD OF THE INVENTION

Embodiments of the present invention are generally related to the field of devices capable of image capture.

### BACKGROUND OF THE INVENTION

Conventional mobile devices, such as smartphones and tablets, include the technology to perform a number of different functions. For example, a popular function available on most conventional mobile devices is the ability to electronically store various forms of contact information (e.g., telephone numbers, electronic mail, text messages, etc.) directly on the mobile device. As such, users may be capable of using the digital capabilities of the mobile device to quickly retrieve desired contact information belonging to an individual.

However, in order to communicate with an individual whose contact information is stored on these conventional mobile devices, generally a user must manually search for and verify the individual's specific contact information in order to ensure that she is using the correct information. Furthermore, this process may prove to be especially cumbersome if a user receives important images of some of their contacts and wishes to immediately communicate with those specific contacts using the mobile device.

### SUMMARY OF THE INVENTION

Accordingly, a need exists for a solution that enables users to store and retrieve contact information associated with an individual or a group of individuals in a quick and efficient manner. Embodiments of the present invention are operable to store contact information associated with contacts present within an image as metadata within the image itself. As such, viewers of the image may use the stored contact information to communicate with those present in the image in an easy way. Using face detection procedures, embodiments of the present invention can detect the presence of multiple of contacts within an image. Embodiments of the present invention can also associate the faces detected within the image with contacts belonging to a list of contacts stored on a mobile device. In this fashion, upon rendering an image, the user can automatically initiate a communication (e.g., call) with a contact in the image by clicking on the contact's image or can automatically create a conference call by clicking on more than one contact present in the image. Furthermore, embodiments of the present invention allow users to provide contact information manually for any unrecognized subjects found in the image. Additionally, embodiments of the present invention are operable to export contact information associated with recognizable contacts found into the image. Furthermore, embodiments of the present invention can encrypt contact information stored within the image.

More specifically, in one embodiment, the present invention is implemented as a method of storing contact information. The method includes capturing an image using a camera system. The method also includes automatically detecting a face within said image to identify a recognizable contact associated with the face. In one embodiment, the automatically detecting further includes detecting the face using automated face detection procedures resident on the mobile device. In one embodiment, the automatically detecting further includes automatically determining an association between the recognizable contact and the face using image data operable to associate the recognizable contact with the face. Furthermore, the method includes, using the mobile device, automatically storing contact information as metadata within the image responsive to a detection of the recognizable contact within the image to produce an encoded image, in which the contact information comprises stored contact information associated with the recognizable contact.

In one embodiment, the method includes detecting an unrecognized face within the image and the automatically storing further includes prompting a user to enter new contact information associated with the unrecognizable face detected and storing the new contract information on the encoded image, in which the unrecognizable face is associated with the new contact information. In one embodiment, the method includes communicating the encoded image to a remote client device over a communications network, in which the encoded image is operable to display the contact information on the remote client device and execute an application on the remote client device for communicating with the recognizable contact. In one embodiment, the method includes displaying the encoded image on a display of the mobile device and, responsive to a user selecting a recognized face in the image, initiating a communication with a recognized contact associated with the recognized face. In one embodiment, the communication is one of: a phone call; a text message and an electronic mail message.

In one embodiment, the present invention is implemented as a system for storing contact information. The system includes an image capture module operable to capture an image. The system also includes a detection module operable to detect a face within the image to identify a recognizable contact associated with the face. In one embodiment, the detection module is further operable to detect the face using automated face detection procedures. In one embodiment, the detection module includes a determination module operable to determine an association between the recognizable contact and the face automatically using image data operable to associate the recognizable contact with the face. Furthermore, the system includes a storage module operable to store contact information as metadata within the image responsive to a detection of the recognizable contact within the image to produce an encoded image, in which the contact information comprises stored contact information associated with the recognizable contact. In one embodiment, the detection module is operable to detect an unrecognized face within the image and the storage module is further operable to prompt a user to enter new contact information associated with the unrecognizable face detected and store the new contract information on the encoded image, in which the unrecognizable face is associated with the new contact information.

In one embodiment, the system includes a communication module operable to communicate the encoded image to a remote client device over a communications network, in which the encoded image is operable to display the contact information on the remote client device and execute an application on the remote client device for communicating with the recognizable contact. In one embodiment, the system includes a display device operable to display the encoded image and a communication module operable to initiate a communication with the recognized contact responsive to a user selecting a recognized face in the image. In one embodiment, the communication module is further operable to initiate the communication using one of: a phone call; a text message and an electronic mail message.

In one embodiment, the present invention is implemented as a method of storing contact information. The method includes retrieving an image from memory resident on a mobile device. The method also includes detecting a first face within the image to identify a first recognizable contact associated with the first face. In one embodiment, the detecting further includes detecting the first face using automated face detection procedures resident on the mobile device, in which the detecting further comprises determining an association between the first recognizable contact and the first face automatically using image data operable to associate the first recognizable contact with the first face.

Furthermore, the method includes, using the mobile device, storing a first set of contact information as metadata within the image responsive to a detection of the first recognizable contact within the image to produce an encoded image, in which the first set of contact information comprises stored contact information associated with the first recognizable contact.

In one embodiment, the method includes detecting an unrecognized face within the image and the automatically storing further includes prompting a user to enter new contact information associated with the unrecognizable face detected and storing the new contract information on the encoded image, in which the unrecognizable face is associated with the new contact information. In one embodiment, the method includes communicating the encoded image to a remote client device over a communications network, in which the encoded image is operable to display the first set of contact information on the remote client device and execute an application on the remote client device for communicating with the first recognizable contact.

In one embodiment, the method includes displaying the encoded image on a display and, responsive to a user selecting the first recognized face in the image, initiating a communication with the first recognized contact. In one embodiment, the communication is one of: a phone call; a text message and an electronic mail message. In one embodiment, the method includes detecting a second face within the image to identify a second recognizable contact associated with the second face and, using the mobile device, storing a second set of contact information as metadata within the image responsive to a detection of the second recognizable contact within the image to produce an encoded image, in which the second set of contact information comprises stored contact information associated with the second recognizable contact, and displaying the image and, responsive to a user selecting the first and second recognizable contacts in the image, initiating a conference communication with the first and second recognizable contacts.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A depicts an exemplary system in accordance with embodiments of the present invention.

FIG. 1B depicts an exemplary face recognition process performed when storing contact information in an image in accordance with embodiments of the present invention.

FIG. 2 depicts an exemplary face detection process performed when storing contact information in an image in accordance with embodiments of the present invention.

FIG. 3A depicts an exemplary data structure capable of storing data associated with contacts recognized by the system in accordance with embodiments of the present invention.

FIG. 3B depicts an exemplary contact recognition process performed when storing contact information in an image in accordance with embodiments of the present invention.

FIG. 3C depicts an exemplary contact storage process performed when storing contact information in an image in accordance with embodiments of the present invention.

FIG. 4A depicts another exemplary contact storage process performed when storing contact information in an image in accordance with embodiments of the present invention.

FIG. 4B depicts an exemplary image containing stored contact information in accordance with embodiments of the present invention.

FIG. 4C depicts an exemplary use case of communicating with a contact using contact information stored in an image in accordance with embodiments of the present invention.

FIG. 5 is a flow chart depicting an exemplary process of displaying stored contact information embedded within an image in accordance with embodiments of the present invention.

FIG. 6 is a flow chart depicting an exemplary process of communicating stored contact information embedded within an image to remote client device over a communications network in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

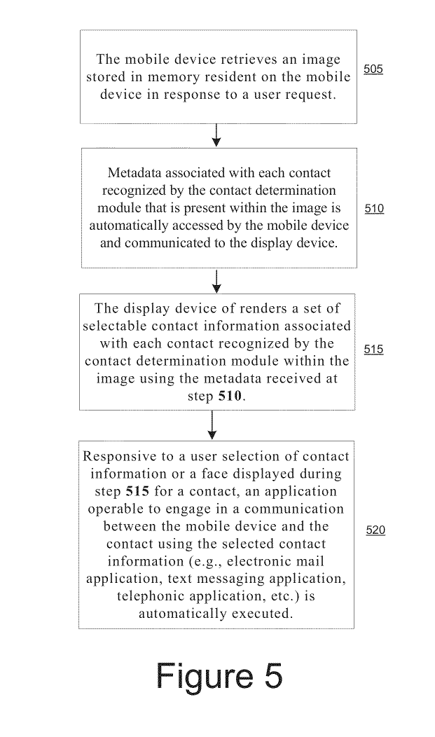

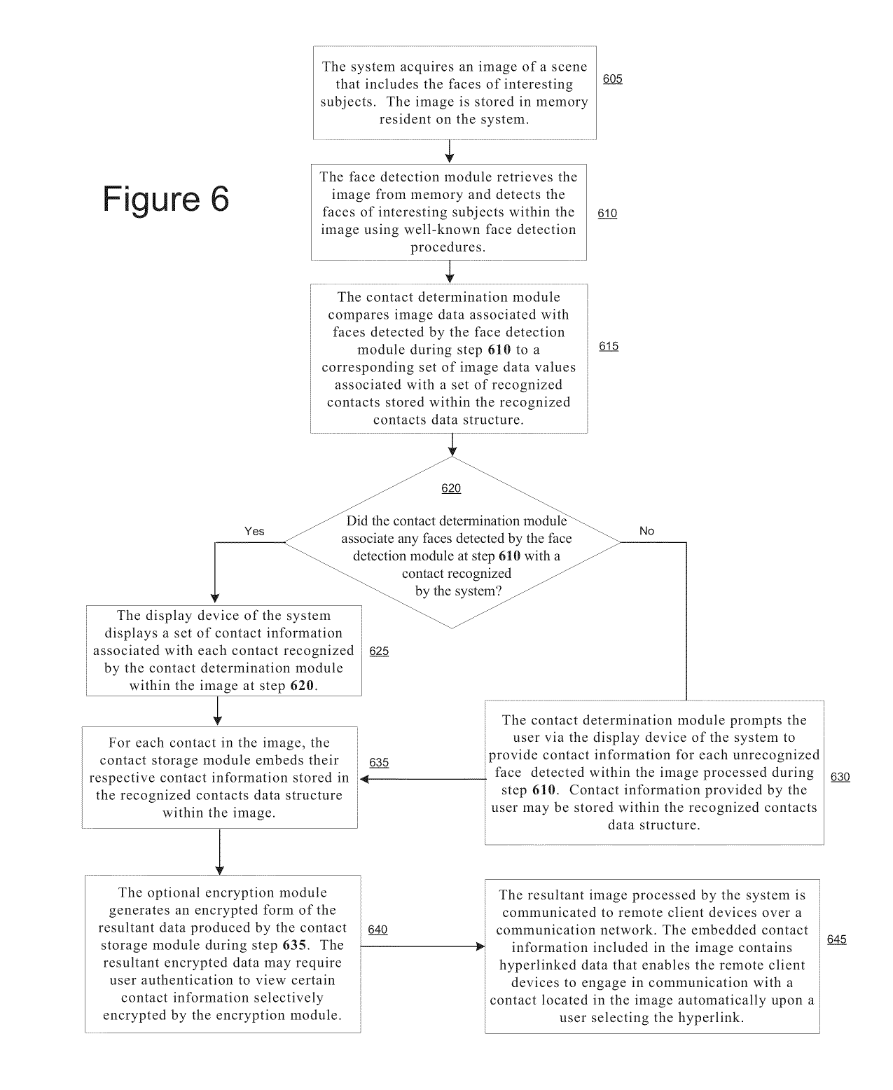

Portions of the detailed description that follow are presented and discussed in terms of a process. Although operations and sequencing thereof are disclosed in a figure herein (e.g., FIGS. 5, 6 etc.) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, a subject, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon. Also, as used in this application, the term “contact” is intended to refer to any party that may be have a connection to a user, which may include, but is not limited to, an associate, relative, friend, acquaintance, or any connections of the like.

### Exemplary System in Accordance with Embodiments of the Present Invention

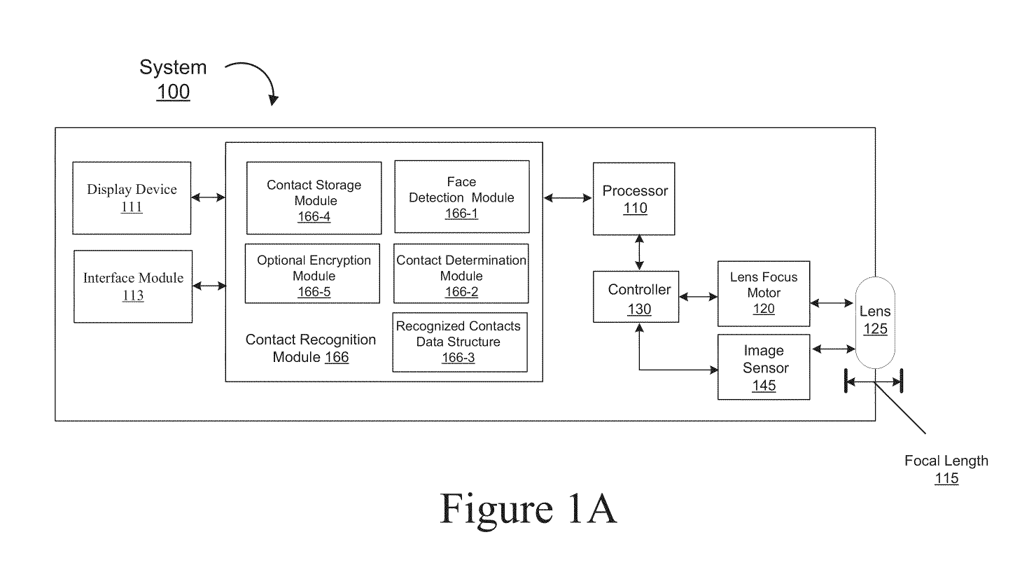

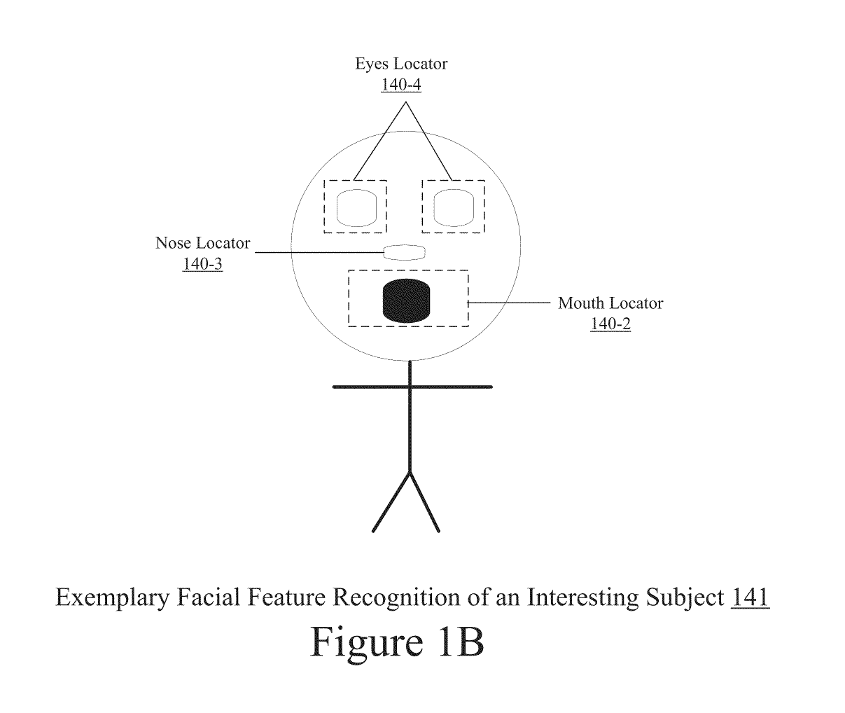

As presented in FIG. 1A, an exemplary system 100 upon which embodiments of the present invention may be implemented is depicted. System 100 can be implemented as, for example, a digital camera, cell phone camera, portable electronic device (e.g., audio device, entertainment device, handheld device), webcam, video device (e.g., camcorder) and the like. As illustrated in the embodiment depicted in FIG. 1A, system 100 may comprise lens 125, lens focus motor 120, image sensor 145, controller 130, image processor 110, contact recognition module 166, display device 111 and interface module 113. In one embodiment, contact recognition module 166 may comprise face detection module 166-1, contact determination module 166-2, recognized contacts data structure 166-3, contact storage module 166-4, and optional encryption module 166-5. Additionally, components of system 100 may be coupled via internal communications bus and may receive/transmit image data for further processing over such communications bus.

According to one embodiment of the present invention, face detection module 166-1 may include the functionality to use well-known face detection procedures (e.g., template matching, etc.) to detect the presence of faces within a given image. Images used during face detection procedures may be acquired via lens 125 and subsequently processed by components of system 100 (e.g., image processor 110). As illustrated by the embodiment depicted in FIG. 1A, system 100 may be operable to receive image data associated with scenes external to system 100 captured through lens 125. Lens 125 may be placed in a position determined by controller 130, which uses focus motor 120 as a mechanism to position lens 125. As such, focus motor 125 may be operable to move lens 125 along lens focal length 115, which may result in varying degrees of focus quality in terms of sharpness. According to one embodiment, image sensor 145 may comprise an array of pixel sensors operable to gather image data from scenes external to system 100 via lens 125. Image sensor 145 may also include the functionality to capture and convert light received via lens 125 into signal data (e.g., digital or analog) capable of being processed by image processor 110. Image processor 110 may output the processed image data into memory buffers (not pictured) located in memory resident on system 100 for further processing by components of system 100. Although system 100 depicts only lens 125 in the FIG. 1A illustration, embodiments of the present invention may support multiple lens configurations and/or multiple cameras (e.g., stereo cameras). In one embodiment, images used during contact recognition procedures may be acquired by system 100 over a communications network (e.g., via interface module 113) or through removable storage medium and stored in memory resident on system 100 for further processing.

With further reference to the embodiment depicted in FIG. 1A, face detection module 166-1 may include the functionality to use well-known face detection procedures to detect the presence of faces in images acquired by system 100. In one embodiment, face detection module 166-1 may be capable of processing the pixel data of various different subsections within an image stored within memory resident on system 100. In one embodiment, face detection module 166-1 may be configured to process image subsections of various shapes and/or sizes in parallel. Additionally, according to one embodiment, face detection module 166-1 may include the functionality to measure different facial features associated with a detected face for use in facial recognition procedures by embodiments of the present invention. For example, with reference to the embodiment depicted in FIG. 1B, face detection module 166-1 may be include the functionality to measure the relative position, shape and/or size of various detected facial features such as cheek bones, nose, eyes, and/or the jaw bone using well-known face detection procedures capable of measuring those particular facial features (e.g., mouth locator 140-2; nose locator 140-3; eyes locator 140-4).

According to one embodiment, a contact “recognized” by system 100 may be a party (e.g., business entity, individual, etc.) that is mapped to a set of contact information stored on system 100. In one embodiment, system 100 may be configured to receive user-defined mappings which map contacts to a specific set of contact information. For example, in one embodiment, a user may use a graphical user interface (GUI) displayed on display device 111 to map a contact to a set of contact information belonging to that contact. In this manner, contact information associated with each “recognized contact” may include, but is not limited to, contact names, email addresses, telephone numbers and the like. As such, in one embodiment, information included within the set of contact information may be stored within recognized contacts data structure 166-3, which may be operable to store various forms of contact information associated with each recognized contact.

According to one embodiment, recognized contacts data structure 166-3 may be operable to store images depicting recognized contacts. In one embodiment, system 100 may be configured to enable a user to map an image depicting a contact to a set of contact information belonging to that contact. As such, pixel values associated with the mapped image may be stored within recognized contacts data structure 166-3 and used for reference purposes by contact determination module 166-2 when determining associations between a face detected by face detection module 166-1 and a contact recognized by system 100. In one embodiment, recognized contacts data structure 166-3 may be operable to store facial feature data capable of uniquely identifying contacts recognized by system 100 during face recognition procedures. In one embodiment, system 100 may be configured to use machine-learning procedures to map an image depicting a contact to a set of contact information associated with that contact. For example, in one embodiment, system 100 may be trained to correlate images of a particular contact with a set of contact information belonging to that contact.

Contact determination module 166-2 may include the functionality to determine associations between faces detected by face detection module 166-1 and contacts recognized by system 100 in real-time. According to one embodiment, in response to a face detection (e.g., determined via face detection module 166-1), contact determination module 166-2 may include the functionality to compare image data associated with the detected face to a corresponding set of image data values associated with a set of recognized contacts stored within recognized contacts data structure 166-3. According to one embodiment, contact determination module 166-2 may be configured to compare pixel values (e.g., pixel coordinates) processed by face detection module 166-1 for a detected face to values of a corresponding set of pixel values stored within recognized contacts data structure 166-3 belonging to a recognized contact. As such, if the pixel values associated with the detected face are determined to be within a pixel value threshold of a particular recognized contact, contact determination module 166-2 may associate the detected face with the recognized contact. In one embodiment, thresholds used to correlate a detected face with a recognized contact stored within recognized contacts data structure 166-3 may be predetermined. Additionally, in one embodiment, upon a determination made by contact determination module 166-2 that a detected face is not associated with a recognized contact, contact determination module 166-2 may be configured to prompt a user (e.g., via display device 111) to provide contact information associated with the unrecognized face detected by face detection module 166-1. As such, the user may be prompted to provide contact information (e.g., email address, telephone number, etc.), which may be subsequently stored in recognized contacts data structure 166-3.

According to one embodiment, contact determination module 166-2 may include the functionality to use well-known face recognition procedures to associate a detected face with a recognizable contact. For example, according to one embodiment, contact determination module 166-2 may be configured to distinguish faces of subjects based on the detected facial features associated with a given subject using data gathered by face detection module 166-1. As such, the values associated with a set of facial features measured by face detection module 166-1 may be compared by contact determination module 166-1 to a set of corresponding facial feature values belonging to a recognized contact stored within recognized contacts data structure 166-3. Accordingly, if the measured values of the facial features are determined to be within a threshold value of a particular recognized contact, contact determination module 166-2 may associate the detected face with the recognized contact.

Contact storage module 166-4 may include the functionality to store (e.g., embed) contact information within images stored on system 100. According to one embodiment, storage procedures may be performed by contact storage module 166-4 upon user request. For example, a user may select a button displayed within a GUI on display device 111 to engage storage procedures. Images selected for storage procedures may be acquired via lens 125 and subsequently processed by components of system 100 (e.g., image processor 110). In one embodiment, images selected for storage procedures by contact storage module 166-4 may be acquired by system 100 over a communications network (e.g., via interface module 110) or through removable storage medium.

According to one embodiment, contact storage module 166-4 may include the functionality to store contact information within images stored on system 100 responsive to determinations made by contact determination module 166-2. For example, in one embodiment, upon a determination made by contact determination module 166-2 that a face detected within an image is associated with a recognized contact, contact storage module 166-4 may be configured to embed contact information contact (e.g., email address, telephone number, etc.) stored within recognized contacts data structure 166-3 associated with that recognized contact as metadata within the image. In one embodiment, the metadata may include coordinate data (e.g., 2 dimensional coordinates) providing the coordinates of faces detected by face detection module 166-1 that enables other systems and/or devices to display the contact information of a contact recognized by system 100 in a proximate position relative to that contact (e.g., information displayed adjacent to contact) within an image processed by contact storage module 166-4.

Additionally, in one embodiment, if contact determination module 166-2 determines that a detected face is not associated with a recognized contact, contact storage module 166-4 may be configured to prompt a user (e.g., via contact determination module 166-2) to provide contact information associated with the unrecognized face detected by face detection module 166-1. As such, the user may be prompted to provide contact information (e.g., email address, telephone number, etc.), which may be subsequently stored in recognized contacts data structure 166-3 and embedded within the image by contact storage module 166-4.

Optional encryption module 166-5 may include the functionality to encrypt resultant contact information produced by system 100 (e.g., contact storage module 166-4) into conventional formats using well-known encryption procedures. In one embodiment, optional encryption module 166-5 may include the functionality to encrypt all contact information associated with recognized contacts whose contact information may have been stored within an image during storage procedures performed by contact storage module 166-4. Additionally, in one embodiment, optional encryption module 166-5 may be configured to selectively encrypt contact information associated with a recognized contact based on user-defined preferences. For example, a user may select certain contact information embedded within an image by contact storage module 166-4 to require user authentication in order to view. As such, in one embodiment, optional encryption module 166-5 may be configured to encrypt the resultant data in a manner that requires a user to provide a password in order to view the encrypted contact information.

Interface module 113 may include the functionality to communicate resultant images produced by system 100 to conventional electronic devices operable to receive and display the resultant images produced. According to one embodiment, interface module 113 may include the functionality to communicate encoded image outputs produced by contact storage module 166-4 and/or optional encryption module 166-5 to conventional electronic devices via an electronic communications network, including wired and/or wireless communication and including the Internet. According to one embodiment, interface module 113 may include the functionality to communicate encoded image outputs produced by contact storage module 166-4 and/or optional encryption module 166-5 to conventional electronic devices through a removable storage medium (e.g., portable memory storage device).

Display device 111 may include the functionality to display image output processed by components of system 100 (e.g., contact recognition module 166, etc.). Examples of display device 111 may include, but are not limited to, a liquid crystal display (LCD), a plasma display, etc. In one embodiment, display device 111 may be a touch-sensitive display device (e.g., electronic touch screen display device) capable of detecting and processing touch events. For example in one embodiment, display device 111 may be operable to process sampling point data associated with touch events performed on display device 111 and make the data available for further processing by other components of system 100. Sampling point data may provide locational information (e.g., touch event coordinates) regarding where contact is made with display device 111. Furthermore, touch events may be provided by sources such as fingers or instruments capable of making contact with a touch surface (e.g., a stylus). Display device 111 may also include the functionality to capture multiple touch events simultaneously.

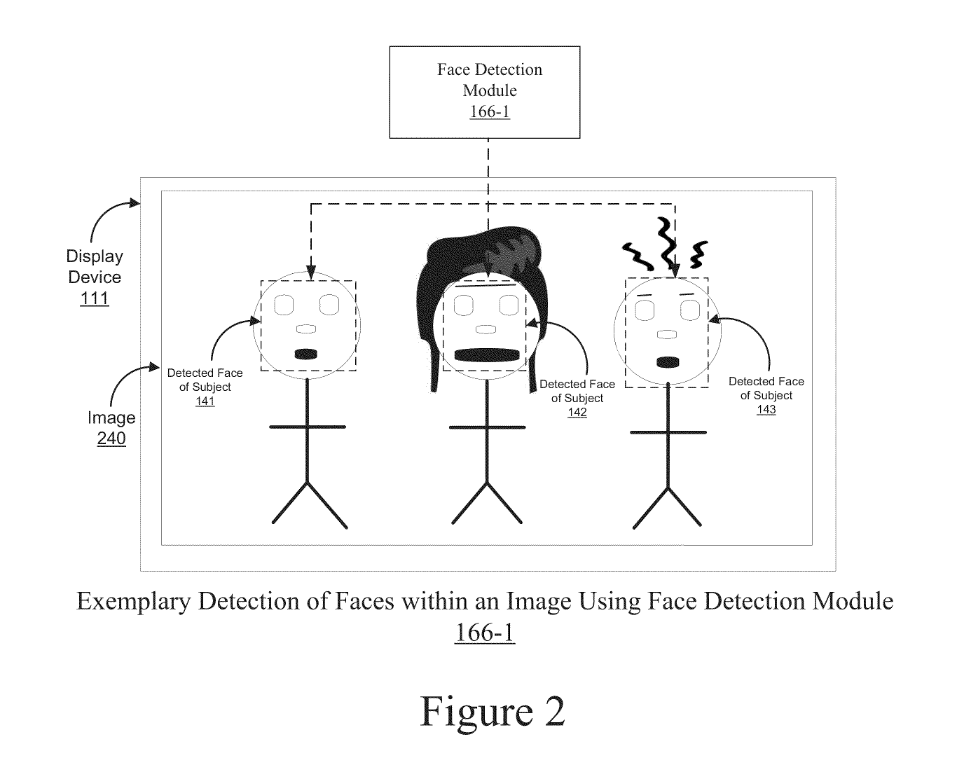

FIG. 2 depicts exemplary face detection procedures performed on an image in accordance with embodiments of the present invention. Image 240 may be an image captured via lens 125 and processed by components within system 100 (e.g., image sensor 145, image processor 110, etc.). In one embodiment, image 240 may be received by system 100 over a communications network and stored in memory resident on system 100 for further processing by components within system 100. Accordingly, face detection module 166-1 may be operable to access image data associated with image 240 from memory resident on system 100 and analyze pixel data to detect the presence of faces using well-known face detection procedures. For example, as illustrated in FIG. 2, face detection module 166-1 may be operable to detect the presence of faces associated with subjects 141, 142 and 143 and concurrently identify their current location (e.g., pixel coordinates) within image 240. As such, face detection module 166-1 may provide components of system 100 (e.g., contact determination module 166-3) with processed image data that includes the location coordinates of faces that were detected.

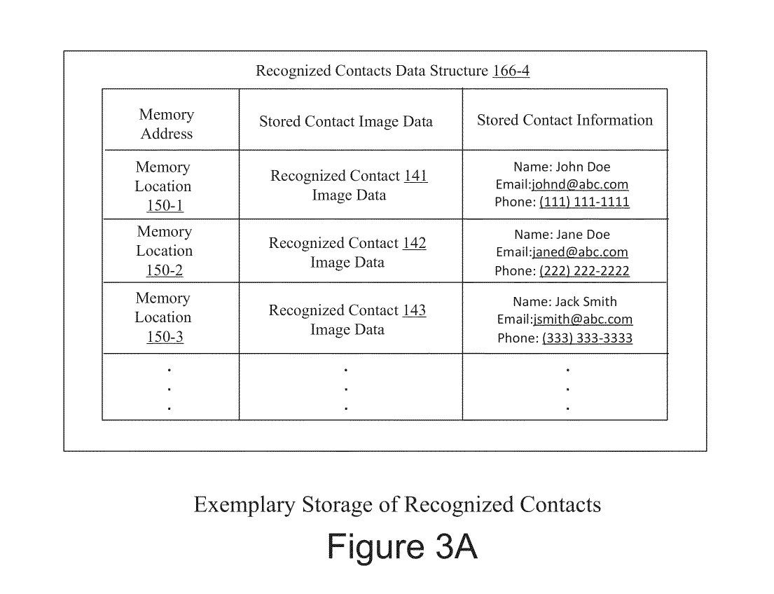

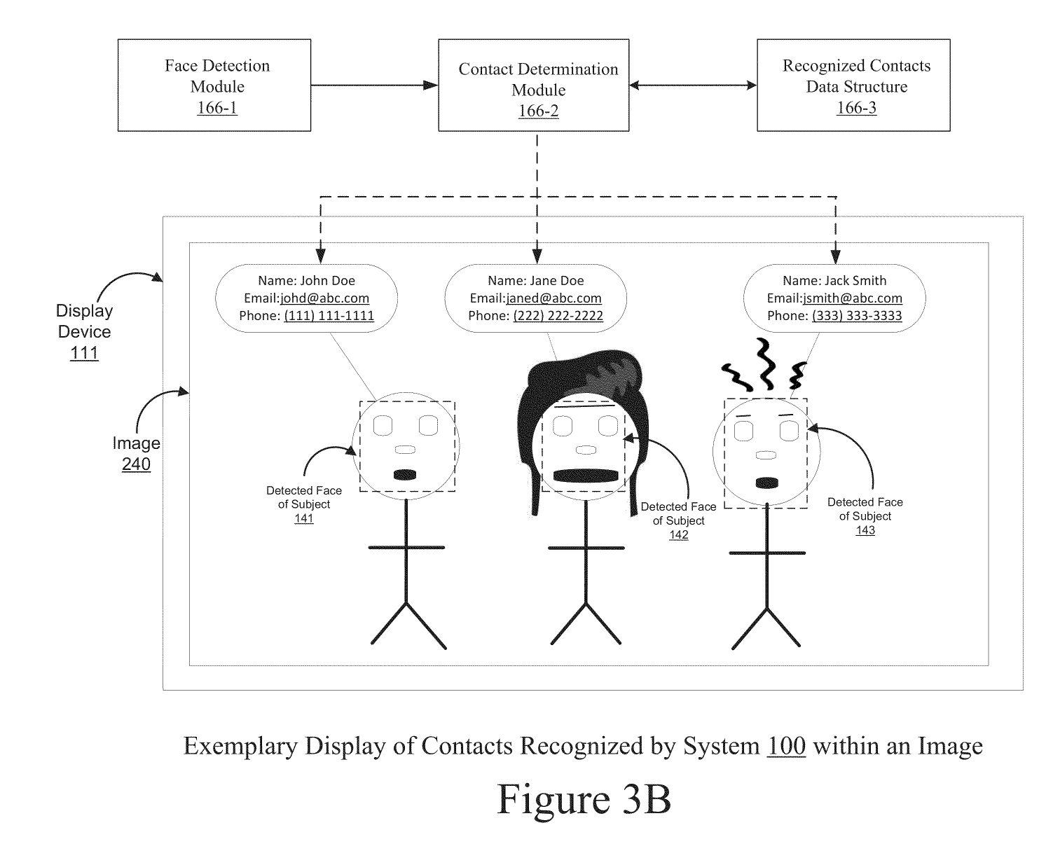

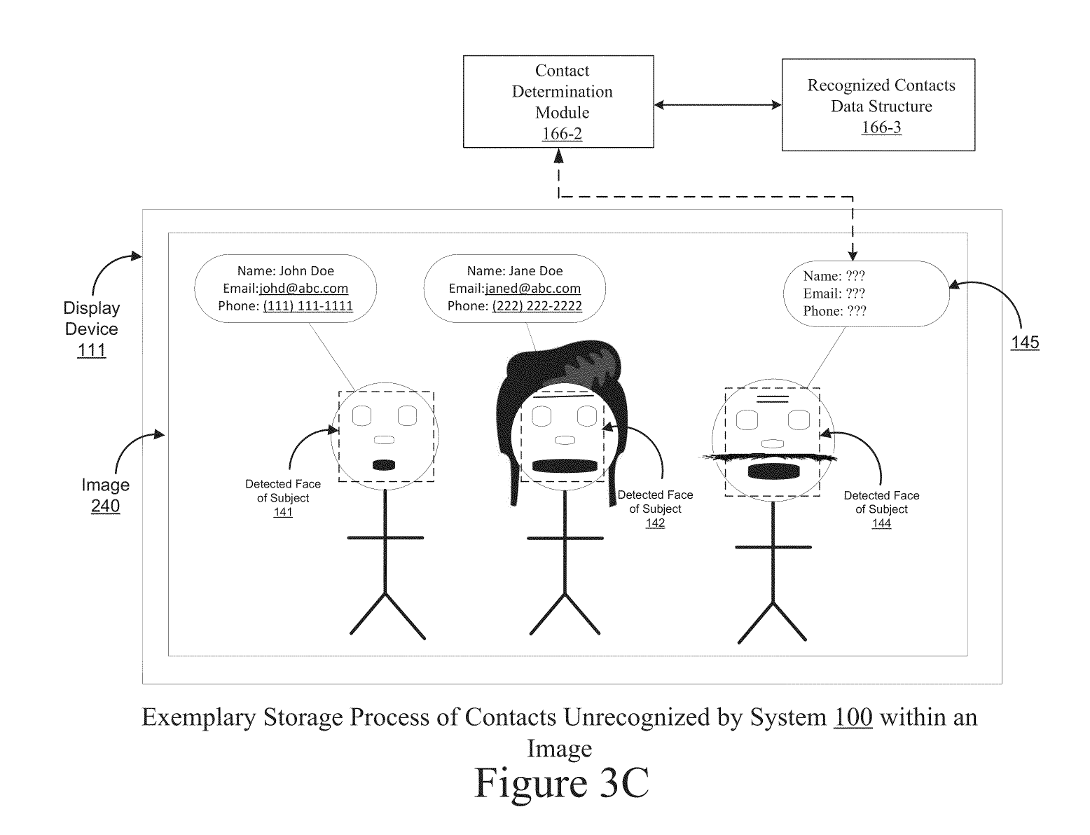

FIG. 3A depicts an exemplary data structure capable of storing data associated with contacts recognized by system 100 in accordance with embodiments of the present invention. As illustrated by the embodiment depicted in FIG. 3A, data associated with each recognized contact may be mapped to location in memory (e.g., memory locations 150-1, 150-2, 150-3, 150-4, etc.). As such, image data associated with recognized contacts may be stored and used for reference by contact determination module 166-2 when analyzing image data provided by face detection module 166-1. For example, in one embodiment, pixel values within a set of subsections analyzed by face detection module 166-1 may be compared by contact determination module 166-2 to pixel values of a corresponding set of subsections belonging a recognized contact (e.g., recognized contacts 141, 142, 143, etc.) stored within recognized contacts data structure 166-3. Additionally, data stored in recognized contacts data structure 166-4 may include various forms of contact information associated with each recognized contact. For example, contact information associated with each recognized contact may include, but is not limited to, contact names, email addresses, telephone numbers and the like.

Furthermore, according to one embodiment, data stored in recognized contacts data structure 166-3 may be used during facial recognition procedures to detect recognizable contacts within a given image under analysis by system 100 (e.g., image 240). For instance, according to one embodiment, data stored in recognized contacts data structure 166-3 may include image data depicting various representations (e.g., scaled representations, rotated representations, etc.) that may be used by contact determination module 166-2 to associate detected faces with contacts recognized by system 100. It should be appreciated that embodiments of the present invention are not limited to the types or amount of data described in FIG. 3A with respect to the recognized data structure 166-3. As such, data structures implemented by embodiments of the present invention may include more or less data than those described in FIG. 3A.

FIG. 3B depicts an exemplary contact recognition process used to determine correlations between faces detected and recognized contacts stored on system 100 in accordance with embodiments of the present invention. As illustrated in FIG. 3B, contact determination module 166-2 may receive processed image data from face detection module 166-1 and compare the data to a corresponding set of values associated with recognized contacts stored within recognized contacts data structure 166-3. If the pixel values associated with a detected face are within a pixel value threshold of a particular recognized contact, contact determination module 166-2 may associate the detected face with that recognized contact.

Additionally, as illustrated by the embodiment depicted in FIG. 3B, positive correlations between a detected face and a recognized stored contact may be displayed via display device 111 as geometric shapes or “bubbles” adjacent to their respective contacts as recognized by contact determination module 166-2 within a given image (e.g., image 240). Accordingly, these shapes may include any contact information associated with the recognized contact that may be stored within recognized contacts data structure 166-3. For example, upon associating the detected face of subject 141 with recognized contact “John Doe”, display device 111 may display contact information stored within recognized contacts data structure 166-3 associated with the John Doe in real-time (e.g., John Doe's name, email address, phone number, etc.).

Additionally, with reference to the embodiment depicted in FIG. 3C, upon a determination made by contact determination module 166-2 that a detected face is not associated with a recognized contact, the user may be prompted (e.g., via display device 111) with a text entry field or window (e.g., prompt 145) to provide contact information associated with the unrecognized face detected by face detection module 166-1. For example, the face of detected subject 144 may not be recognized by contact determination module 166-2. As such, the user may be prompted to provide contact information (e.g., email address, telephone number, etc.) for detected subject 144 which may be subsequently stored in recognized contact data structure module 166-3.

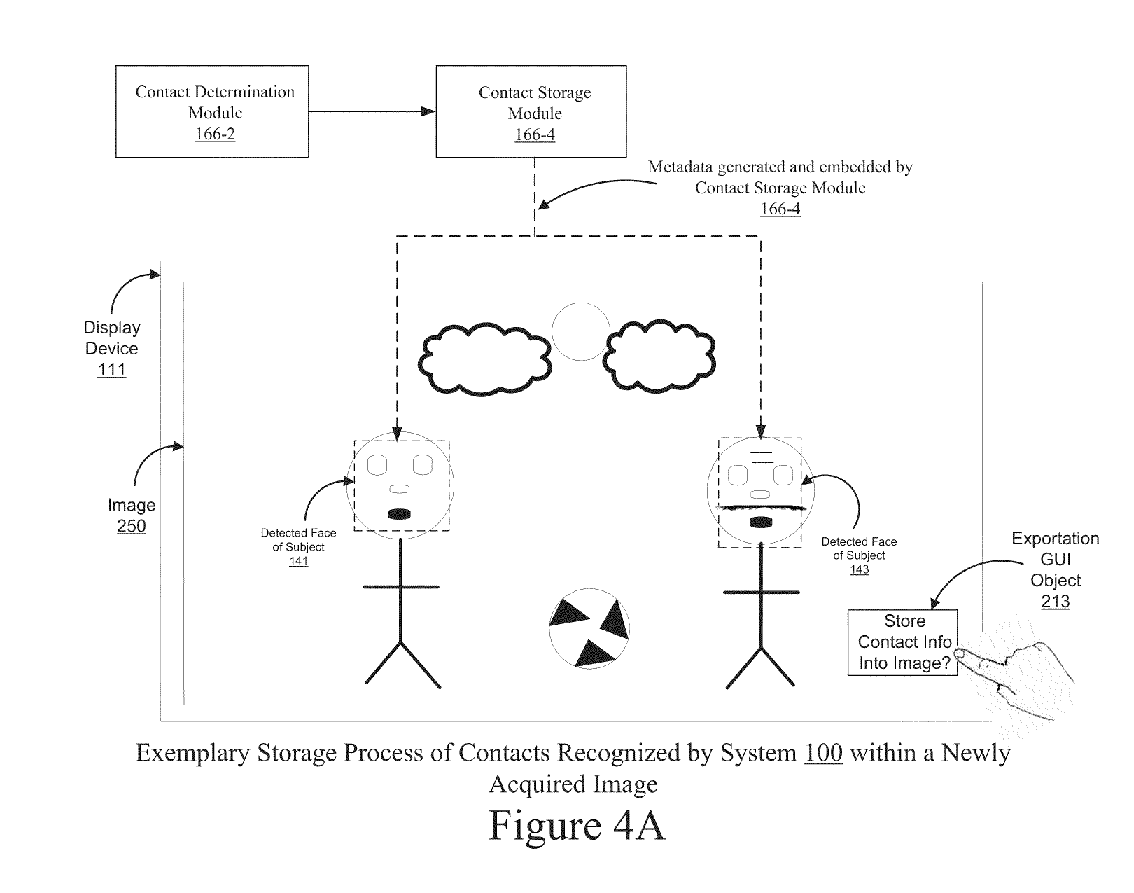

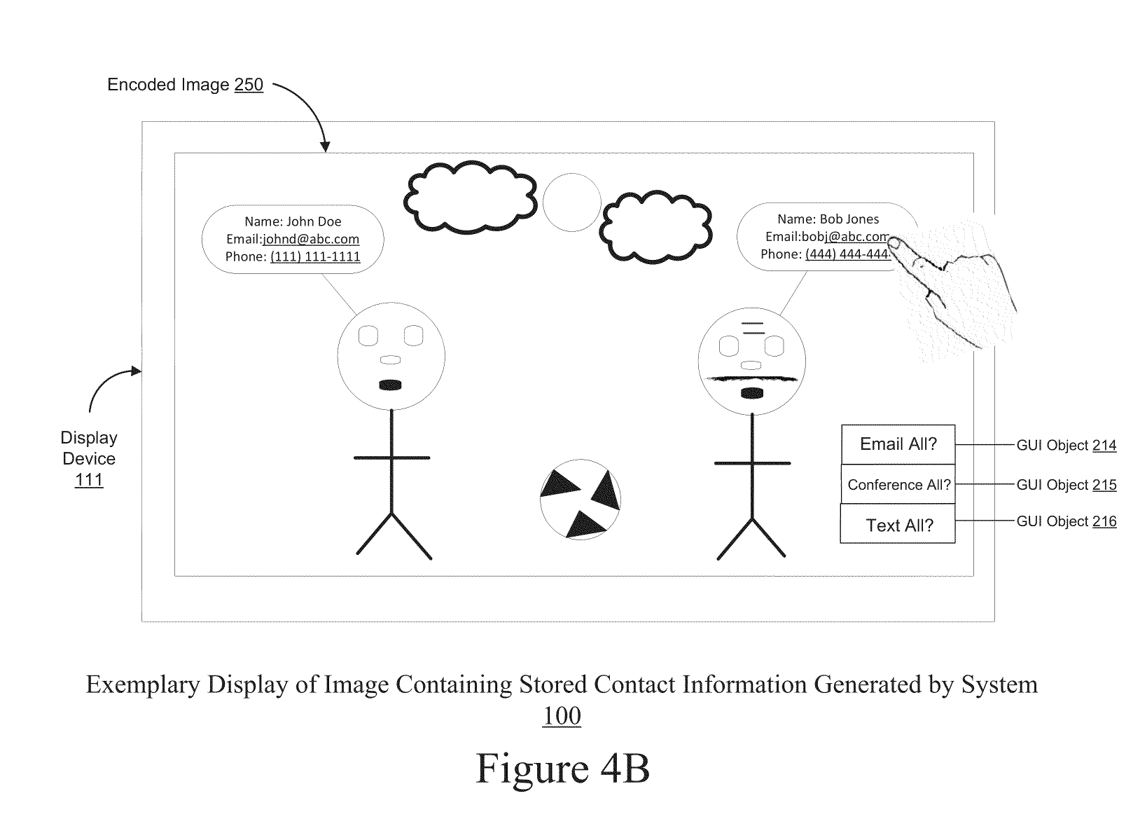

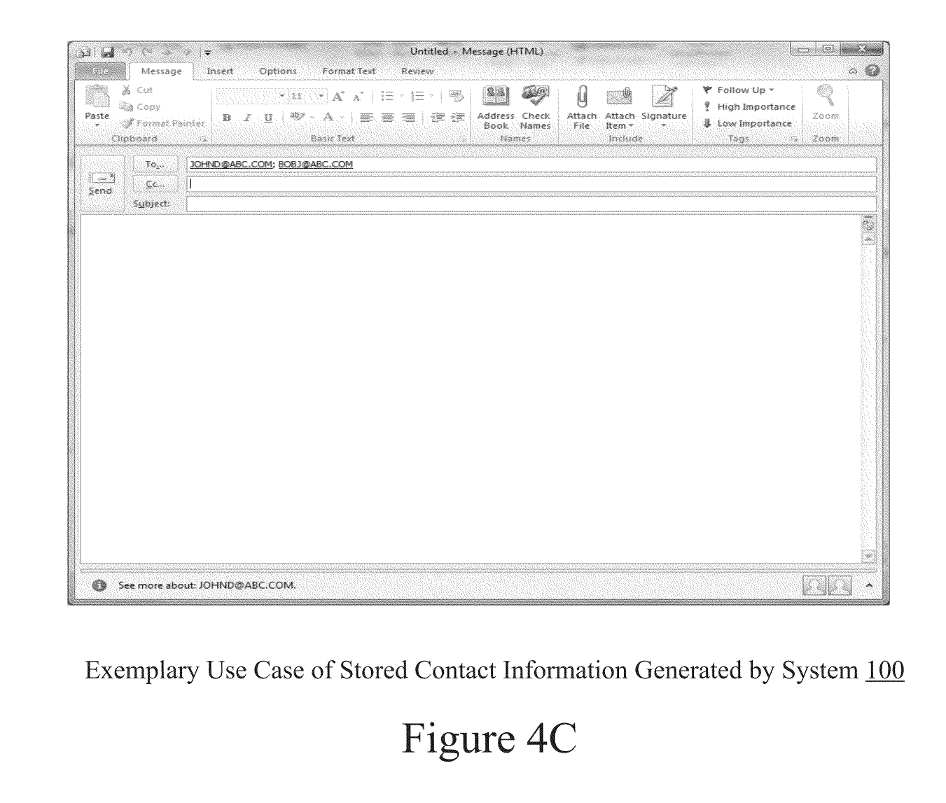

FIGS. 4A and 4B depict an exemplary contact information storage process performed in accordance with embodiments of the present invention. With reference to FIG. 4A, image 250 may be a newly acquired image captured via lens 125 and processed by components within system 100. In one embodiment, image 250 may be an image received by system 100 over a communications network and stored in memory resident on system 100 for further processing by components within system 100. As illustrated in FIG. 4A, storage procedures may be performed by contact storage module 166-4 upon user request (e.g., user selecting GUI object 213). Also, as illustrated in FIG. 4A, upon a determination made by contact determination module 166-2 that the faces of detected subjects 141 and 143 are associated with recognized contacts, contact storage module 166-4 may be configured to embed their respective contact information (e.g., email address, telephone number, etc.) as metadata within image 250. Furthermore, according to one embodiment, during the storage process, if a determination is made by contact determination module 166-2 that a detected face is not associated with a recognized contact, contact storage module 166-4 may be configured to prompt a user (e.g., via contact determination module 166-2) to provide contact information associated with the unrecognized face detected by face detection module 166-1. As such, the user may be prompted to provide contact information, which may be subsequently stored within the image by contact storage module 166-4.

FIG. 4B depicts an exemplary image containing stored contact information in accordance with embodiments of the present invention. In one embodiment, the embedded metadata may include coordinate data (e.g., 2 dimensional coordinates) that enables display device 111 to display the contact information of recognized contacts (e.g., contacts “John Doe” and “Bob Jones”) in a manner relative to their respective contacts within encoded image 250 to users viewing the image. As such, recognized contacts “John Doe” and “Bob Jones” may have their stored contact information (e.g., names, email addresses, telephone numbers) optionally simultaneously displayed to a user via the display device (e.g., display device 111) so that a user may engage in a communication with each contact present in the image. Additionally, as illustrated in FIG. 4B, encoded image 250 may provide users with options to perform group communications involving all contacts using the metadata embedded in encoded image 250 (e.g., GUI objects 214, 215, 216). Furthermore, embodiments of the present invention may enable users to perform functions that involve the image itself when communicating with contacts present in the image. For example, in one embodiment, encoded image 250 may be encoded by storage module 166-4 in a manner that allows users viewing the image to email and/or text encoded image 250 to all contacts present in the image.

Embodiments of the present invention may also be configured to automatically engage in a communication with a recognized contact present in an image immediately upon a user selection of the contact's face. For example, in one embodiment, an application (e.g., electronic mail application, text messaging application, telephonic application, etc.) may be pre-configured to execute responsive to a user pressing on the area of the image depicting the face of “John Doe” and/or “Bob Jones” within encoded image 250. In one embodiment, a list of applications providing various mediums of communication with “John Doe” and/or “Bob Jones” resident on system 100 (e.g., electronic mail application, text messaging application, telephonic application, etc.) may be presented to the user upon the user's selection of the contact's face.

Furthermore, according to one embodiment, system 100 may be operable to communicate encoded image 250 from system 100 via interface module 113 to a plurality of remote client devices over a communication network or through a removable storage medium (e.g., portable memory storage device). In one embodiment, remote client devices may be conventional electronic devices operable to receive and display encoded image 250 in a manner similar to system 100.

With reference to the embodiment depicted in FIG. 4C, a user may wish to communicate with each recognized contact present in an image in a single instance using a single medium (e.g., multiple party teleconference, electronic mail correspondence, etc.). For example, with reference to FIG. 4C, a user may wish to include both “John Doe” and “Bob Jones” within the same electronic mail correspondence. As such, the user may select their respective hyperlinked contact information (e.g., hyperlinked email addresses) displayed via the display device 111 (see FIG. 4B). Accordingly, a conventional electronic mail application may be executed by system 100 such that the application correspondingly generates a new correspondence addressed to recognized contacts “John Doe” and “Bob Smith” using their respective electronic mail addresses received from encoded image 250.

According to one embodiment, a user may wish to communicate with recognized contacts “John Doe” and “Bob Jones” simultaneously by engaging them in a multiple-party telephone conference. As such, the user may select their respective hyperlinked telephone numbers provided by encoded image 250 and displayed on display device 111. Accordingly, system 100 may correspondingly execute a telephone application configured to add each contact as a participant to the telephone call using their respective telephone numbers.

Furthermore, according to one embodiment, a user may wish to communicate with recognized contacts “John Doe” and “Bob Jones” simultaneously by engaging them in a SMS text message. As such, the user may select their respective hyperlinked telephone numbers provided by encoded image 250 and displayed on display device 111. Accordingly, system 100 may correspondingly execute an SMS texting application configured to generate a new correspondence that includes recognized contacts “John Doe” and “Bob Jones” using their respective telephone numbers or electronic mail addresses.

According to one embodiment, system 100 may be operable to communicate encoded image 250 from system 100 via interface module 113 to a plurality of remote client devices over a communication network or through a removable storage medium (e.g., portable memory storage device). As such, in one embodiment, remote client devices may be conventional electronic devices operable to execute a conventional electronic mail application that automatically generates a new correspondence addressed to recognized contacts “John Doe” and “Bob Smith” using their respective electronic mail addresses (e.g., hyperlinked data) received from encoded image 250. According to one embodiment, system 100 may be operable to communicate an encrypted form of encoded image 250 from system 100 using optional encryption module 166-5 to a plurality of remote client devices over a communication network or through a removable storage medium (e.g., portable memory storage device). As such, remote client devices receiving the encrypted form of encoded image 250 may require user-authentication in order to view the stored information.

FIG. 5 is a flow chart depicting an exemplary process of displaying stored contact information embedded within an image in accordance with embodiments of the present invention.

At step 505, the mobile device retrieves an image stored in memory resident on the mobile device in response to a user request.

At step 510, metadata associated with each contact recognized by the contact determination module that is present within the image is automatically accessed by the mobile device and communicated to the display device.

At step 515, the display device renders a set of selectable contact information associated with each contact recognized by the contact determination module within the image using metadata received at step 510.

At step 520, responsive to a user selection of contact information or a face displayed during step 515 for a contact, an application operable to engage in a communication between the mobile device and the contact using the selected contact information (e.g., electronic mail application, text messaging application, telephonic application, etc.) is automatically executed.

FIG. 6 is a flow chart depicting an exemplary process of communicating stored contact information embedded within an image to remote client device over a communications network in accordance with embodiments of the present invention.

At step 605, the system acquires an image of a scene that includes the faces of interesting subjects. The image is stored in memory resident on the system.

At step 610, the face detection module retrieves the image from memory and detects the faces of interesting subjects within the image using well-known face detection procedures.

At step 615, the contact determination module compares the image data associated with faces detected by the face detection module during step 610 to a corresponding set of image data values associated with a set of recognized contacts stored within the recognized contacts data structure.

At step 620, a determination is made as to whether the contact determination module associated any faces detected by the face detection module at step 610 with a contact recognized by the system. If the contact determination module associated any faces to a contact recognized by the system, then the display device of the system displays a set of contact information associated with each contact recognized by the contact determination module within the image at step 620, as detailed in step 625. If the contact determination module did not associate a face to a contact recognized by the system, then the contact determination module prompts the user via the display device of the system to provide contact information for each unrecognized face detected within the image processed during step 610. Contact information provided by the user may be stored within the recognized contacts data structure, as detailed in step 630.

At step 625, the contact determination module associated a face to a contact recognized by the system and, therefore, the display device of the system displays a set of contact information associated with each contact recognized by the contact determination module within the image at step 620.

At step 630, the contact determination module did not associate a face to a contact recognized by the system and, therefore, the contact determination module prompts the user via the display device of the system to provide contact information for each unrecognized face detected within the image processed during step 610. Contact information provided by the user may be stored within the recognized contacts data structure.

At step 635, for each contact in the image, the contact storage module embeds their respective contact information stored in the recognized contacts data structure within the image.

At step 640, the optional encryption module generates an encrypted form of the resultant data produced by the contact storage module during step 635. The resultant encrypted data may require user authentication to view certain contact information selectively encrypted by the encryption module.

At step 645, the resultant image processed by the system is communicated to remote client devices over a communication network. The embedded contact information included in the image contains hyperlinked data that enables the remote client devices to engage in communication with a contact located in the image automatically upon a user selecting the hyperlink.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because much other architecture can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of storing contact information, said method comprising:
capturing an image using a camera system;
automatically detecting a face within said image to identify a recognizable contact associated with said face; and
using said mobile device, automatically storing contact information as metadata within said image responsive to a detection of said recognizable contact within said image to produce an encoded image, wherein said contact information comprises stored contact information associated with said recognizable contact.

2. The method as described in claim 1, wherein said automatically detecting further comprises detecting said face using automated face detection procedures resident on said mobile device.

3. The method as described in claim 1, wherein said automatically detecting further comprises automatically determining an association between said recognizable contact and said face using image data operable to associate said recognizable contact with said face.

4. The method as described in claim 1, further comprising detecting an unrecognized face within said image and wherein said automatically storing further comprises prompting a user to enter new contact information associated with said unrecognizable face detected and storing said new contract information on said encoded image, wherein said unrecognizable face is associated with said new contact information.

5. The method as described in claim 1, further comprising communicating said encoded image to a remote client device over a communications network, wherein said encoded image is operable to display said contact information on said remote client device and execute an application on said remote client device for communicating with said recognizable contact.

6. The method as described in claim 1, further comprising:
displaying said encoded image on a display of said mobile device; and
responsive to a user selecting a recognized face in said image, initiating a communication with a recognized contact associated with said recognized face.

7. The method as described in claim 6, wherein said communication is one of: a phone call; a text message and an electronic mail message.

8. A system for storing contact information, said system comprising:
an image capture module operable to capture an image;
a detection module operable to detect a face within said image to identify a recognizable contact associated with said face; and
a storage module operable to store contact information as metadata within said image responsive to a detection of said recognizable contact within said image to produce an encoded image, wherein said contact information comprises stored contact information associated with said recognizable contact.

9. The system as described in claim 8, wherein said detection module is further operable to detect said face using automated face detection procedures.

10. The system as described in claim 8, wherein said detection module comprises a determination module operable to determine an association between said recognizable contact and said face automatically using image data operable to associate said recognizable contact with said face.

11. The system as described in claim 8, wherein said detection module is operable to detect an unrecognized face within said image and wherein said storage module is further operable to prompt a user to enter new contact information associated with said unrecognizable face detected and store said new contract information on said encoded image, wherein said unrecognizable face is associated with said new contact information.

12. The system as described in claim 8, further comprising a communication module operable to communicate said encoded image to a remote client device over a communications network, wherein said encoded image is operable to display said contact information on said remote client device and execute an application on said remote client device for communicating with said recognizable contact.

13. The system as described in claim 8, further comprising:
a display device operable to display said encoded image and a communication module operable to initiate a communication with said recognized contact responsive to a user selecting a recognized face in said image.

14. The system as described in claim 13, wherein said communication module is further operable to initiate said communication using one of: a phone call; a text message and an electronic mail message.

15. A method of storing contact information, said method comprising:
retrieving an image from memory resident on a mobile device;
detecting a first face within said image to identify a first recognizable contact associated with said first face; and
using said mobile device, storing a first set of contact information as metadata within said image responsive to a detection of said first recognizable contact within said image to produce an encoded image, wherein said first set of contact information comprises stored contact information associated with said first recognizable contact.

16. The method as described in claim 15, wherein said detecting further comprises detecting said first face using automated face detection procedures resident on said mobile device, wherein said detecting further comprises determining an association between said first recognizable contact and said first face automatically using image data operable to associate said first recognizable contact with said first face.

17. The method as described in claim 15, further comprising detecting an unrecognized face within said image and wherein said automatically storing further comprises prompting a user to enter new contact information associated with said unrecognizable face detected and storing said new contract information on said encoded image, wherein said unrecognizable face is associated with said new contact information.

18. The method as described in claim 15, further comprising communicating said encoded image to a remote client device over a communications network, wherein said encoded image is operable to display said first set of contact information on said remote client device and execute an application on said remote client device for communicating with said first recognizable contact.

19. The method as described in claim 15, further comprising:
displaying said encoded image on a display; and
responsive to a user selecting said first recognized face in said image, initiating a communication with said first recognized contact.

20. The method as described in claim 19, wherein said communication is one of: a phone call; a text message and an electronic mail message.

21. The method as described in claim 15, further comprising:
detecting a second face within said image to identify a second recognizable contact associated with said second face;
using said mobile device, storing a second set of contact information as metadata within said image responsive to a detection of said second recognizable contact within said image to produce an encoded image, wherein said second set of contact information comprises stored contact information associated with said second recognizable contact;
displaying said image; and
responsive to a user selecting said first and second recognizable contacts in said image, initiating a conference communication with said first and second recognizable contacts.
